(19) United States
(12) Patent Application Publication
(10) Pub. No.: US 2025/0256527 A1
(43) Pub. Date: Aug. 14, 2025

(54) RECYCLED MATERIALS FOR USE IN SUBSTRATES FOR SECURE INSTRUMENTS

(71) Applicant: Spectra Systems Corporation, Providence, RI (US)

(72) Inventor: Nabil Lawandy, Saunderstown, RI (US)

(21) Appl. No.: 18/440,574

(22) Filed: Feb. 13, 2024

(51) Int. Cl. B42D 25/29; B42D 25/48; C10G 1/06; C10G 1/10; C10G 69/12

(52) U.S. Cl. CPC B42D 25/29; B42D 25/48; C10G 1/06; C10G 1/10; C10G 69/12; C10G 2300/1003

(57) ABSTRACT

A substrate for a banknote, an associated banknote, and an associated method for producing a substrate for a banknote, where the substrate has a composition thereof, where the substrate includes a chemically-recycled polymer material or a purification-recycled polymer material, and where at least 20% of the composition of the substrate includes the chemically-recycled polymer material or the purification-recycled polymer material.

### TECHNICAL FIELD

The present invention relates to processes for producing substrates for secure instruments composed of recycled materials. More particularly, the present invention relates to chemically-recycled or purification-recycled polymer materials acceptable for use in substrates for secure instruments.

### BACKGROUND OF THE INVENTION

Many countries, concerned about the environmental impact of their banknotes, are now utilizing polymer-based banknotes. As countries continue to adopt the Paris Climate Accords and strive to use more sustainable materials, the environmental impact of their currency as well as the associated durability and security of the currency are being considered.

Banknotes have been made from a variety of materials over the centuries, such as leather during the Han Dynasty in China to shells, precious metals, cotton paper, and most recently plastic. These materials often reflect the social and political climate of the time as well as the available technologies and resources.

Paper became the currency of choice around the world and has remained so for several centuries. However, with recent technological developments, plastic film banknotes offer additional security features along with improved longevity and energy efficiency. Polymer banknotes first issued in 1988 in Australia, which now employs polymer exclusively. Polymers are currently used in over 50 countries as diverse as Australia, Canada, Fiji, Mauritius, New Zealand, Papua New Guinea, Romania, Vietnam, and the United Kingdom.

The Bank of Canada moved to polymer banknotes starting in 2011, after assessing the environmental impact of producing paper and plastic bills. A life-cycle assessment examined the effect, including primary energy demands and the potential for global warming, of each stage of production, such as from growing the cotton to producing the banknote paper or producing the raw material for polymer banknotes through the destruction and disposal of worn banknotes. In all categories and phases, polymer outperformed paper. Studies have shown that a polymer bill promises a 32 percent reduction in global warming potential and 30 percent reduction in primary energy demand compared with paper. Most importantly, polymer banknotes last more than twice as long as paper banknotes, which means fewer polymer banknotes have to be manufactured and distributed over the life of a series. Additionally, polymer banknotes weigh less than paper banknotes, which results in the benefit of transportation and distribution being more environmentally friendly. At the end of their life, paper bills are usually shredded and relegated to a landfill. Polymer banknotes, however, may be taken out of circulation, shredded, converted into pellets, and then used to make every day plastic items, such as lawn furniture.

The Bank of England spent three years studying the potential effect of a switch from cotton and linen paper banknotes and also concluded the superiority of plastic. A polymer £5 note featuring Sir Winston Churchill was launched in 2016, followed by a £10 Jane Austen note and a £20 note.

Recycled plastics have been used in many products, from bottles to industrial parts to clothing; however, to date, there is only a very restricted use in banknote foil substrates used as security features. Major obstacles to the use of recycled polymers for banknotes include the requirements of high clarity and low haze (<3%) of the signature window feature of polymer banknotes as well as the demanding tensile strength requirements, typically above 120/m², regardless of whether the substrate is isotropic blown film or made using a tenter process with machine and transverse mechanical properties. In addition, the substrate must have a surface energy typically above 40 dyne/cm. All of these requirements must be achieved to manufacture a polymer banknote including a significant portion of recycled material in the raw materials before extrusion.

Recycling, both mechanically or chemically, can produce two types of products. If the properties of the recycled material are not considerably different from those of the original material and can be used in the same application, the recycling process is a closed-loop recycling process. This approach is difficult for the mechanical recycling of some polymers for specific applications because the processing of plastic waste causes partial degradation of the polymer structure and changes to its mechanical properties. When recycled material has different properties and is used in different applications from the original application, the recycling process is called an open-loop recycling process. In the case of polymer banknotes, the use of closed-and open-loop recycling processes using mechanical methodologies is not possible. Accordingly, there is a need in the art for recycling processes using chemical methodologies to produce acceptable and usable banknote substrates.

### SUMMARY OF THE INVENTION

In general, in one aspect, the invention features a substrate for a banknote, the substrate having a composition thereof, the substrate including a chemically-recycled polymer material, where at least 20% of the composition of the substrate includes the chemically-recycled polymer material.

Implementations of the invention may include one or more of the following features. The chemically-recycled polymer material may be a polyolefin, and the polyolefin may be polyethylene, polypropylene, or combinations thereof. The chemically-recycled polymer material may be polypropylene, at least 25% of the composition of the substrate may include the chemically-recycled polymer material, and the substrate may be a biaxially oriented polypropylene (BOPP) substrate. The substrate may further include a purification-recycled polymer material. A banknote may also include the substrate.

In general, in another aspect, the invention features a substrate for a banknote, the substrate having a composition thereof, the substrate including a purification-recycled polymer material, where at least 20% of the composition of the substrate includes the purification-recycled polymer material.

Implementations of the invention may include one or more of the following features. The purification-recycled polymer material may be a polyolefin, and the polyolefin may be polyethylene, polypropylene, or combinations thereof. The purification-recycled polymer material may be polypropylene, at least 25% of the composition of the substrate may include the purification-recycled polymer material, and the substrate may be a biaxially oriented polypropylene (BOPP) substrate. The purification-recycled polymer material may be obtained by solvent-based physical separation. The substrate may further include a chemically-recycled polymer material. A banknote may also include the substrate.

In general, in another aspect, the invention features a method for producing a substrate for a banknote, the substrate having a composition thereon, the method including sorting an amount of waste material including a polymer material to obtain an amount of the polymer material, cleaning the amount of the polymer material, performing a pyrolysis process on the amount of the polymer material to obtain a liquid polymer output, hydrotreating the liquid polymer output to obtain a hydrotreated polymer output, performing a steam cracking process on the hydrotreated polymer output to obtain a steam cracked polymer output, performing a polymerization process on the steam cracked polymer output to obtain a chemically-recycled polymer material, and forming a substrate including the chemically-recycled polymer material for a banknote, where at least 20% of the composition of the substrate includes the chemically-recycled polymer material.

Implementations of the invention may include one or more of the following features. The cleaning step may include one or both of washing and purification of the amount of the polymer material. A fossil-based feedstock may be included with the hydrotreated polymer output during the steam cracking process. The amount of waste material may include a source of a recyclable polymer material other than polymer-based banknotes. The chemically-recycled polymer material may be a polyolefin, and the polyolefin may be polyethylene, polypropylene, or combinations thereof. The chemically-recycled polymer material may be polypropylene, at least 25% of the composition of the substrate may include the chemically-recycled polymer material, and the substrate may be a biaxially oriented polypropylene (BOPP) substrate.

### BRIEF DESCRIPTION OF THE DRAWINGS

FIG. 1 shows a flowchart of a chemical process of the present invention capable of producing a recycled polymer that may be employed as a substrate for secure instruments.

### DETAILED DESCRIPTION OF THE INVENTION

The present invention is directed to the production of substrates for secure instruments composed of recycled materials. In a preferred embodiment, a chemical recycling process or a purification recycling process is employed to recycle polymer materials into a condition acceptable for use in secure instrument substrates. The secure instrument substrate may be the substrate for a banknote, a tax stamp, a credit card, a bank card, a license, or an identification document.

The present invention may utilize any known polymer capable of chemical recycling and/or purification recycling and use as a banknote substrate. The polymer material to be recycled is preferably not already in the form of a secure instrument, e.g., a polymer banknote. In a preferred embodiment, the recycled polymer is a polyolefin, including but not limited to polyethylene or polypropylene. Polyolefins are inert, have low thermal conductivity, i.e., excellent insulators, and are not subject to degredation by most chemicals. Additionally, as thermoplastic resins, most polyolefins can be mechanically recycled. However, in view of their hydrocarbon chemical structure, polyolefins are also acceptable materials for chemical recycling, such as via cracking, i.e., pyrolysis, gasification, thermal oxidative destruction in an aqueous oxygen-enriched media, and purification recycling, such as those involving solvent-based physical separation. Such a purification recycling process may include providing feedstock material, performing extraction by adding solvent, mixing and settling, filtering, and finally solvent recovery to produce the recycled polyolefin. A non-limiting example of a purification recycling process involving solvent-based physical separation that is suitable for use in connection with the present invention is described in U.S. Patent Application Publication No. U.S. 2018/0171094 A1, the entirety of which is incorporated by reference herein.

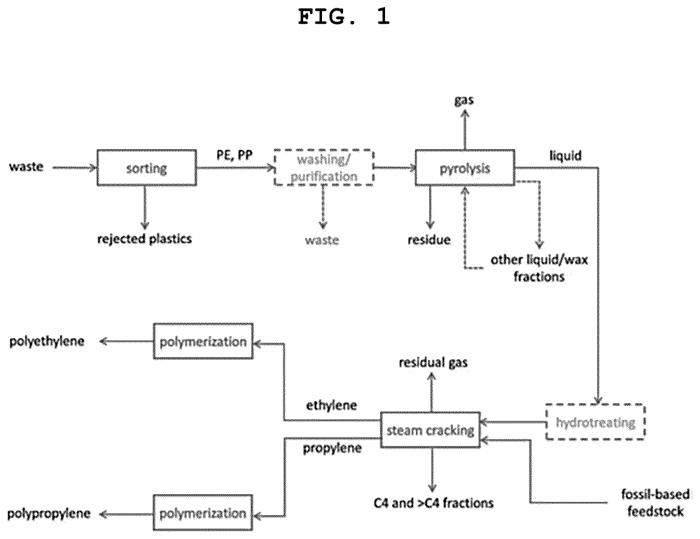

FIG. 1 provides an exemplary chemical process of the present invention for the production of a recycled polymer suitable for use as a substrate for secure instruments. In particular, waste material including the polymer to be recycled is sorted, such as for polyolefins, with the desired polymer material being subsequently washed/purified. The polymer material is then subjected to a pyrolysis process, with the liquid output being hydrotreated and combined with a fossil-based feedstock for a steam cracking process. In the case of polyolefins polyethylene and polypropylene, ethylene and propylene are produced by the steam crack process and subject to polymerization to generate the recycled polyolefins polyethylene and polypropylene that are used in a secure instrument substrate.

A recycled substrate for secure instruments of the present invention, such as for a hybrid polymer banknote, may contain at least 20% of the chemically-or purification-recycled polymer material, such as in the instance of a polyolefin-based substrate for secure instruments. In a specific example, a recycled substrate for secure instruments of the present invention may contain at least 25% chemically-or purification-recycled polypropylene along with additional polymers to produce biaxially oriented polypropylene (BOPP), such as for banknotes and other financial instruments including credit cards.

The embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of this disclosure. The objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

What is claimed is:

1. A substrate for a banknote, the substrate having a composition thereof, the substrate comprising:
a chemically-recycled polymer material,
wherein at least 20% of the composition of the substrate comprises the chemically-recycled polymer material.

2. The substrate of claim 1, wherein the chemically-recycled polymer material is a polyolefin.

3. The substrate of claim 2, wherein the polyolefin is polyethylene, polypropylene, or combinations thereof.

4. The substrate of claim 1,
wherein the chemically-recycled polymer material is polypropylene,
wherein at least 25% of the composition of the substrate comprises the chemically-recycled polymer material, and
wherein the substrate is a biaxially oriented polypropylene (BOPP) substrate.

5. The substrate of claim 1, further comprising a purification-recycled polymer material.

6. A banknote comprising the substrate of claim 1.

7. A substrate for a banknote, the substrate having a composition thereof, the substrate comprising:
a purification-recycled polymer material,
wherein at least 20% of the composition of the substrate comprises the purification-recycled polymer material.

8. The substrate of claim 7, wherein the purification-recycled polymer material is a polyolefin.

9. The substrate of claim 8, wherein the polyolefin is polyethylene, polypropylene, or combinations thereof.

10. The substrate of claim 7,
wherein the purification-recycled polymer material is polypropylene,
wherein at least 25% of the composition of the substrate comprises the purification-recycled polymer material, and
wherein the substrate is a biaxially oriented polypropylene (BOPP) substrate.

11. The substrate of claim 7, wherein the purification-recycled polymer material is obtained by solvent-based physical separation.

12. The substrate of claim 7, further comprising a chemically-recycled polymer material.

13. A banknote comprising the substrate of claim 7.

14. A method for producing a substrate for a banknote, the substrate having a composition thereon, the method comprising:
sorting an amount of waste material comprising a polymer material to obtain an amount of the polymer material;
cleaning the amount of the polymer material;
performing a pyrolysis process on the amount of the polymer material to obtain a liquid polymer output;
hydrotreating the liquid output to obtain a hydrotreated polymer output;
performing a steam cracking process on the hydrotreated polymer output to obtain a steam cracked polymer output;
performing a polymerization process on the steam cracked polymer output to obtain a chemically-recycled polymer material; and
forming a substrate including the chemically-recycled polymer material for a banknote,
wherein at least 20% of the composition of the substrate comprises the chemically-recycled polymer material.

15. The method of claim 14, wherein the cleaning step includes one or both of washing and purification of the amount of the polymer material.

16. The method of claim 14, wherein a fossil-based feedstock is included with the hydrotreated polymer output during the steam cracking process.

17. The method of claim 14, wherein the amount of waste material includes a source of a recyclable polymer material other than polymer-based banknotes.

18. The method of claim 14, wherein the chemically-recycled polymer material is a polyolefin.

19. The method of claim 18, wherein the polyolefin is polyethylene, polypropylene, or combinations thereof.

20. The method of claim 14,
wherein the chemically-recycled polymer material is polypropylene,
wherein at least 25% of the composition of the substrate comprises the chemically-recycled polymer material, and
wherein the substrate is a biaxially oriented polypropylene (BOPP) substrate.
